(19) United States
(12) Patent Application Publication
(10) Pub. No.: US 2004/0264182 A1
(43) Pub. Date: Dec. 30, 2004

(54) Low voltage driven high brightness LED

(76) Inventor: Yi-Chen Tang, Yonghe City (TW)

Correspondence Address: RABIN & BERDO, P.C., Suite 500, 1101 14 Street, N.W., Washington, DC, 20005, US

(21) Appl. No.: 10/759,301

(22) Filed: Jan. 20, 2004

(30) Foreign Application Priority Data
Jun. 30, 2003 (TW) 92211913

(51) Int. Cl. F21L 4/00

(52) U.S. Cl. 362/208

(57) ABSTRACT

A low voltage driven high brightness LED that applies the lower driving voltage than the known LED and has brighter than the known LED's; the present invention is a packaging with a circuit board on bottom, a voltage regulation IC and a flashing control IC are on the bottom of the circuit board, at least one LED chips are on the top center of the circuit board, these LED chips can be driven with lower voltage and generate brighter light, a single LED packaging generates multiple color flashing function and achieves smaller physical size, stronger structure and convenient to apply effect.

### BACKGROUND OF THE INVENTION

I. Field of the Invention

This invention relates generally to an LED (Light Emitting Diode) and, more specifically, to a low voltage driven high brightness LED that contains a voltage regulation IC and an LED chip inside the packaging, the voltage regulation IC raises the low voltage input power supply to 2 to 2.5 times of the original value to meet the requirement of the LED driving voltage; a built-in flashing control IC and one or more LED chips can achieve single LED with multiple color flashing, smaller physical size, stronger structure and convenient to apply effect.

II. Description of the Prior Art

Heretofore, it is known that the structure of an LED as shown in FIG. 1 is to have packaging 50 in a lamp shape, a pair of electrode 60, 61 are inside the packaging 50, the two electrode 60, 61 stretch downward out of the packaging 50 and become connecting pins.

The known LED's have two kinds of manufacturing processes, LED's with Aluminum, Indium, Gallium and Phosphorous doping can produce LED's with red, orange, yellow and yellow-green color, the driving voltage is around 2.5V; LED's with InGaN doping can produce LED with green, blue and white color, the driving voltage is around 3.5V; the voltage needed to drive electrode 60, 61 depends on what kind of process applied.

If users apply 1.5V batteries to drive these LED's, they need two to three batteries connected in series for 3V or 4.5V as power supply for stable brightness, two to three 1.5V batteries can make the product bulky and heavy, this application is not very convenient.

The known LED's are very often applied on billboards for flashing light, billboards with LED's arranged in order (in straight line, in circle or in flat panel), by on/off in different duration and different color LED's can produce many fancy visual effect; these LED's must be soldered on a circuit board installed on the billboard, and controlled by a control box for on/off duration; many LED's soldered on the circuit board is not easy to manufacture, the control box might be very bulky and might not be convenient to apply.

### SUMMARY OF THE INVENTION

It is therefore a primary object of the invention to provide a low voltage driven high brightness LED to have LED work with power supply with low driving voltage to achieve smaller physical size, generate brighter light and flash multiple color in single LED packaging.

In order to achieve the objective set forth, a low voltage driven high brightness LED in accordance with the present invention is to have at least one LED chip, a voltage regulation IC, a flashing control IC and capacitors installed on a circuit board, then package into a lamp shape, the IC's are to raise voltage and flashing control to achieve low voltage power to drive; generate brighter light, smaller physical size and multiple color by a single LED.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a cross-sectional view of the prior art;

FIG. 2 is a cross-sectional view of the present invention;

FIG. 3 is a circuit block diagram of a further embodiment of the present invention;

FIG. 4 is a perspective view of another application of the present invention;

FIG. 5 is a bottom view of another application of the present invention;

FIG. 6 is a circuit diagram of a further embodiment of the present invention;

FIG. 7 is another circuit diagram of a further embodiment of the present invention.

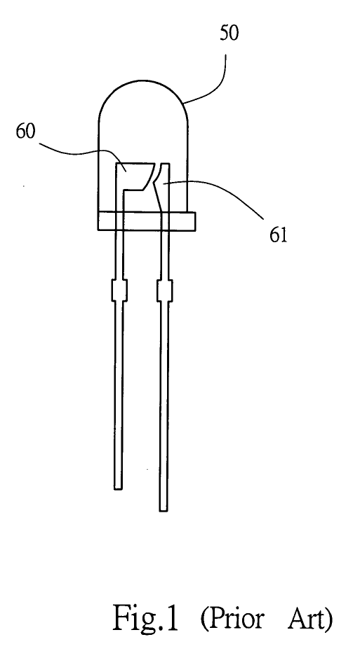

### DESCRIPTION OF THE PREFERRED EMBODIMENT

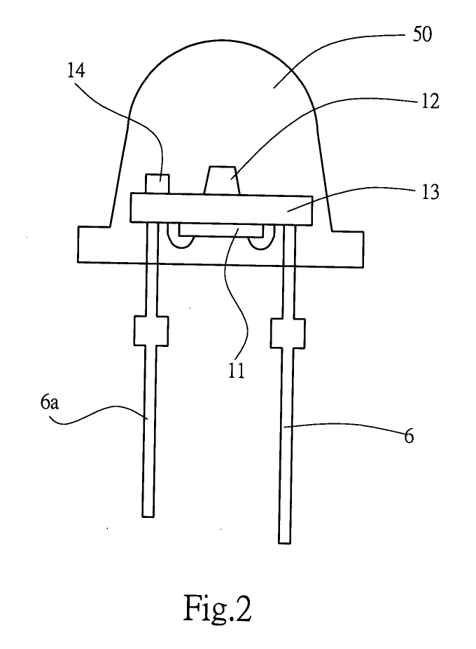

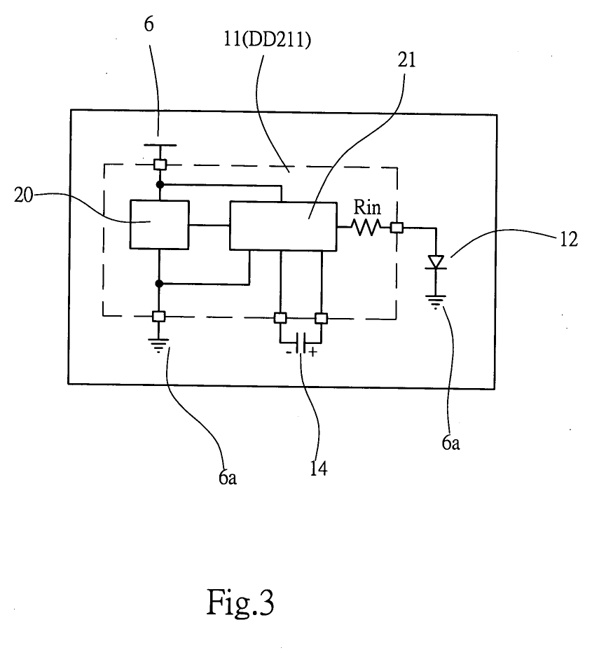

Referring to FIG. 2 that shows each component's relative location inside the packaging 50, the LED chip 12 is a die before packaging, the LED chip 12 is fixed on a circuit board 13 directly then is bonded with bonding wires; or the LED chip 12 is a packaged LED unit and is fixed on the circuit board 13 with SMD (surface mount device) technology; FIG. 3 shows an application block diagram of a voltage regulation IC 11, the part number of voltage regulation IC 11 is DD211; the major characteristic is described as following:

Referring to FIG. 2, the voltage regulation IC 11 is placed on the back of the circuit board 13, the LED chip 12 is installed on the top center of the circuit board 13, a capacitor 14 is on the edge of top of the circuit board 13, two power pin 6 and 6a stretch out from back of the circuit board 13; when all the components are assembled into one main body, they are packed into a packaging 50, two power pin 6 and 6a go out externally to packaging 50 and connect to power supply, power pin 6 connects to positive pole, power pin 6a connects to negative pole.

Based on the structure described above and referring to FIG. 3, the structure inside the dash-line is the block diagram of the voltage regulator IC 11, connecting pin 51 connects to power pin 6, connecting pin 52 connects to power pin 6a, connecting pin 53 connects to the positive pole of the capacitor 14, connecting pin 54 connects to the negative pole of the capacitor 14, connecting pin 55 connects to the current input side of the LED chip 12; to make the LED chip 12 emit light, a driving voltage between 2.5V to 5V is needed; a vibration circuitry turns the 1.5V DC voltage from batteries into AC voltage, the AC voltage can be raised to higher AC voltage after a voltage raising transformer; the voltage regulation circuitry 30 subdivides the raised voltage by time-domain based on the driving voltage needed for the LED chip 12, the subdivided voltage can be stable DC voltage after the filtering of the capacitor 14, the output voltage is 2 to 2.5 times of the input voltage and reaches the voltage above the driving voltage needed by the LED chip 12, no need to have batteries connect in series to raise the voltage, the arrangement reduces the physical size.

The voltage regulation IC 11 not only raises the voltage but also regulates the voltage, regardless the power is higher or lower than the driving voltage needed by the LED chip 12, the voltage regulation IC 11 regulates the voltage into the range needed for the LED chip 12 and maintains the stable driving voltage and current to have the LED chip 12 generate brighter light than known LED's without extra circuitry for easier assembly and lower cost effect.

The voltage regulation IC 11 applies a switching power circuitry and shrinks the circuitry into IC format; FIG. 6 is the theory of the switching power circuitry containing a vibration circuitry 20 and a voltage regulation circuitry 30; when power inputs from connecting pin 51, transistor 22 and 23 are on after the forward bias voltage supplied by the resistor 24 or 25, at the same time, capacitor 26, 27 are charged by the current passing through resistor 29, 28; since the characters of the transistor 22, 23 might not be identical, one transistor with a higher current gain goes to ON stage first than the other one; assuming transistor 22 conducts first. When transistor 22 conducts, C-E pole is on, the positive pole of the capacitor 27 connects to the Emitter of the transistor 23, the negative pole of capacitor 27 connects to the Base of transistor 23, the B-E poles is in reverse bias to make the C-E poles off, the capacitor 26 is charged up to the voltage level of power supply 21 by the current passing through resistor 29 and the B-E pole of transistor 22, and the capacitor 27 discharges; however transistor 22 will not be ON all the time, the capacitor 27 start charging reversely after discharges for certain period of time; when the voltage of the connecting pin 27a is higher than 0.7V, the reverse bias of transistor 23 disappears, transistor 23 has forward bias through resistor 25, transistor 23 switches from off to on. When transistor 23 is ON, the C-E poles of transistor 23 is ON, transistor 22 gets reverse bias by capacitor 26 and is OFF; at this time, capacitor 27 is charged to the same voltage level as power supply 21 and starts discharging, when capacitor 26 finishes discharging, the reverse bias of transistor 22 disappears, transistor 22 starts charging. When the voltage of connecting pin 26a is higher than 0.7V, transistor 22 is ON by having the forward bias by resistor 24; the transistor 22, 23 generate AC current by alternating on and off, the AC current turns to DC current by transformer 31 and a bridge regulator 32, the DC current becomes smooth after the filtering of capacitor 33; the Base of transistor 34 inputs AC current from transformer 31 and makes C-E pole of transistor 34 on and off periodically, such operation makes the Emitter of transistor 34 outputs AC current and charges/discharges capacitor 14, the voltage of capacitor 14 is the output voltage of the voltage regulation IC 11, the output voltage outputs from connecting pin 55; zener diode 36 makes the Base of transistor 37 maintain a stable voltage; when the output voltage of the voltage regulation IC 11 higher than the Base of the transistor 37 by 0.7V, the C-E pole of transistor 37 is on and makes the Base of transistor 38 get voltage in, the C-E pole of transistor 38 is on, after the C-E pole of transistor 38 is on, the current originally input to the Base of transistor 34 goes to ground, the C-E pole of transistor 34 is no longer on, the Emitter of transistor 34 no longer outputs AC current to charge capacitor 14, the output voltage of the voltage regulation IC 11 drops to shut the C-E pole of transistor 37 off. Diode only conducts one way, if the input voltage is high enough to drive LED chip 12 directly, power goes through diode 39 and outputs from connecting pin 55, no necessary to raise the voltage. Based on above description, the voltage regulation IC 11 can raise and stable the voltage.

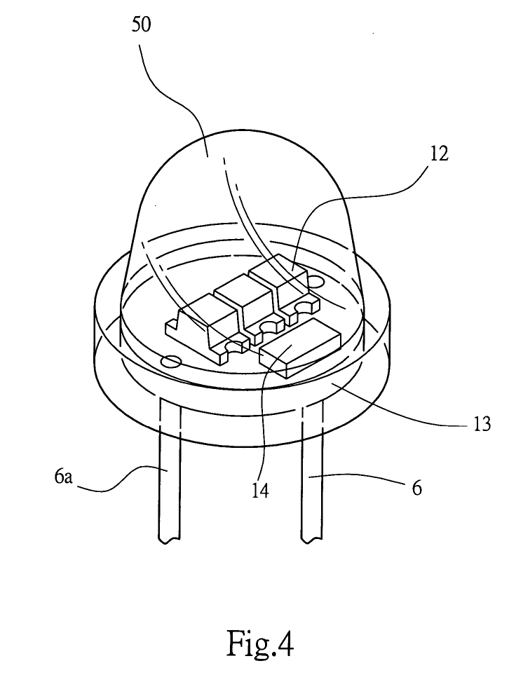

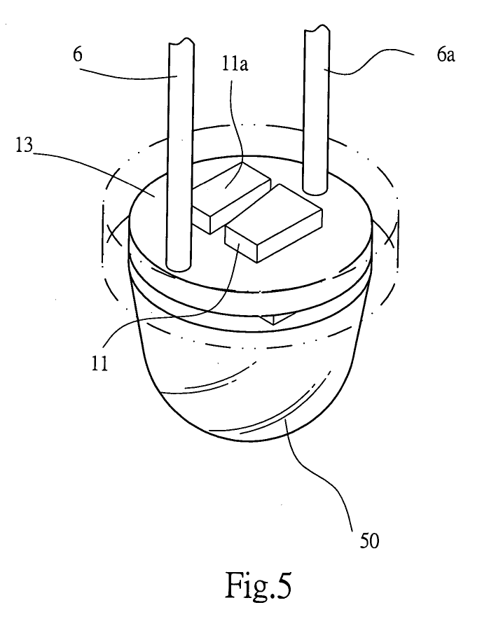

Referring to FIG. 4 and FIG. 5, one or more LED chip 12 can be installed on top center of the circuit board 13, a flashing control IC 11a is installed on back of the circuit board 13, by the control of the flashing control IC 11a, these LED chip 12 can flash in turn or at the same time to achieve a single LED with multiple color and flashing effect.

The internal circuitry of the flashing control IC 11a is similar to the vibration circuitry 20 (as shown in FIG. 7) of FIG. 6, the operation theory is same as the vibration circuitry 20, transistor 22, 23 of the flashing control IC 11a are on and off alternately to make these LED chip 12 flash in turn or at the same time.

Based on above description, the present invention achieves low driving voltage for high brightness LED with flashing effect, and with smaller physical size, easy to assemble and lower cost effect and purpose.

While a preferred embodiment of the invention has been shown and described in detail, it will be readily understood and appreciated that numerous omissions, changes and additions may be made without departing from the spirit and scope of the invention.

What is claimed is:

1. A low voltage driven high brightness LED comprising:
a packaging in lamp shape with an LED chip, two or more connecting pins stretch out from said packaging;
a circuit board inside said packaging;
one or more LED chips are on the top center of said circuit board;
a voltage regulation IC applies the voltage regulation circuitry and the vibration circuitry to raise power voltage, and applies capacitor for voltage filtering to adjust the input power for the normal LED chip driving voltage; and
a flashing control IC is on the back of said circuit board.

2. The low voltage driven high brightness LED recited in claim 1, wherein said flashing control IC drives one or more said LED chips flash in turn or at the same time.

3. The low voltage driven high brightness LED recited in claim 1, wherein said LED chip is a die before packaging, said LED chip is fixed on said circuit board directly then is bonded with wires.

4. The low voltage driven high brightness LED recited in claim 1, wherein said LED chip is a packaged LED unit and is fixed on said circuit board with SMD technology.
